(19) United States
(12) Patent Application Publication
(10) Pub. No.: US 2024/0371549 A1
(43) Pub. Date: Nov. 7, 2024

(54) INTEGRATED HETEROGENEOUS THERMISTOR ARRANGEMENT FOR HIGH VOLTAGE PRE-CHARGE CIRCUIT

(71) Applicant: Littelfuse, Inc., Chicago, IL (US)

(72) Inventors: Tao Guo, Shanghai (CN); TongKiang Poo, Singapore (SG); Jianhua Chen, Sunnyvale, CA (US); Sky Chen, Chicago, IL (US)

(73) Assignee: Littelfuse, Inc., Chicago, IL (US)

(21) Appl. No.: 18/651,881

(22) Filed: May 1, 2024

(30) Foreign Application Priority Data
May 5, 2023 (CN) 2023105063275

(51) Int. Cl. H01C 7/02; H01C 7/04; H01M 10/42; H02H 9/02

(52) U.S. Cl. CPC H01C 7/028; H01C 7/04; H01M 10/425; H02H 9/026; H01M 2200/105; H01M 2200/106

(57) ABSTRACT

A pre-charge circuit. The precharge circuit may include a switching device for controlling a voltage to be supplied to a battery; and a heterogeneous thermistor circuit, coupled to the switching device. The heterogeneous thermistor circuit may include a negative temperature coefficient (NTC) component; and a polymer positive temperature coefficient (PPTC) component, arranged in electrical series with the NTC component and the switching device.

### CROSS-REFERENCE TO RELATED APPLICATION

This application claims priority to Chinese Patent Application serial number 2023105063275, filed May 5, 2023, entitled “INTEGRATED HETEROGENEOUS THERMISTOR ARRANGEMENT FOR HIGH VOLTAGE PRE-CHARGE CIRCUIT,” which is incorporated by reference herein in its entirety.

### BACKGROUND

### Field

Embodiments relate to the field of resistance current suppressor, and more particularly to the suppressor based upon NTC and PPTC materials.

### Discussion of Related Art

In the present day, electric vehicles (EV) and energy storage system (ESS) that are battery powered may include controllers that have high capacitive loads may be used to regulate motors. High voltage (HV) positive and negative contactors are used in an EV and an ESS to act as an emergency disconnect when the motor regulator fails. In present day EVs/ESSs, a pre-charge circuit may be used to avoid contactor damage that would otherwise take place due to high inrush currents. However, such circuitry may include large power resistors that occupy unduly high fraction of the design space for a pre-charge circuit. Using such known pre-charge circuitry, when a circuit problem takes place, such as a short circuit, or main contactor not being properly closed, the large resistor may be burned out quickly.

With respect to this and other considerations the present disclosure is provided.

### BRIEF SUMMARY

In one embodiment, a pre-charge circuit is provided. The precharge circuit may include a switching device for controlling a voltage to be supplied to a battery; and a heterogeneous thermistor circuit, coupled to the switching device. The heterogeneous thermistor circuit may include a negative temperature coefficient (NTC) component; and a polymer positive temperature coefficient (PPTC) component, arranged in electrical series with the NTC component and the switching device.

In another embodiment, a battery circuit may include a first terminal line for connecting an external component to a first terminal of a battery. The battery circuit may also include a first main contactor, connected in series along the first terminal line; and a pre-charge circuit, connected along a pre-charge path that extends parallel to the first main contactor, between the first terminal and the external component. The pre-charge circuit may include a silicon-controlled rectifier (SCR); and a heterogeneous thermistor circuit, coupled in electrical series to the SCR. The heterogeneous thermistor circuit may include a negative temperature coefficient (NTC) component; and a polymer positive temperature coefficient (PPTC) component, arranged in electrical series with the negative temperature coefficient (NTC) component and the SCR.

In a further embodiment, a heterogeneous thermistor circuit for use in a pre-charge circuit is provided. The heterogeneous thermistor circuit may include a negative temperature coefficient (NTC) component; at least one polymer positive temperature coefficient (PPTC) component, arranged in electrical series with the negative temperature coefficient (NTC) component; and a thermal coupler, disposed between the at least one PPTC component and the NTC component.

### BRIEF DESCRIPTION OF THE DRAWINGS

FIG. 1 shows an electric circuit, according to embodiments of the disclosure;

FIG. 2A depicts a perspective view of a heterogeneous thermistor according to embodiments of the disclosure;

FIG. 2B depicts a plan view of an NTC component of a heterogeneous thermistor according to embodiments of the disclosure;

FIG. 2C depicts a plan view of a PPTC component of a heterogeneous thermistor according to embodiments of the disclosure;

FIG. 2D depicts a side view of a heterogeneous thermistor according to embodiments of the disclosure;

FIG. 3A shows a side view of a heterogeneous thermistor circuit according to embodiments of the disclosure;

FIG. 3B shows a side view of another heterogeneous thermistor circuit according to embodiments of the disclosure;

FIG. 3C shows a side view of further heterogeneous thermistor circuit according to embodiments of the disclosure;

FIG. 3D shows a side view of an additional heterogeneous thermistor circuit according to embodiments of the disclosure;

FIG. 3E presents a circuit representation of the embodiment of FIG. 3D;

FIG. 4 is a composite illustration showing a comparison of a known resistor and a heterogeneous thermistor circuit according to embodiments of the disclosure;

FIG. 5A is a composite illustration showing an exemplary set of waveforms for a high voltage DC test, and a summary of DC test results for a heterogeneous thermistor circuit according to embodiments of the disclosure; and

FIG. 5B presents a summary of results for high voltage AC test of a heterogeneous thermistor circuit according to embodiments of the disclosure;

FIG. 5C is a composite illustration showing an exemplary set of waveforms for a high voltage DC test, simulating short circuit conditions, and a summary of DC test results.

### DESCRIPTION OF EMBODIMENTS

The present embodiments will now be described more fully hereinafter with reference to the accompanying drawings, in which exemplary embodiments are shown. The embodiments are not to be construed as limited to the embodiments set forth herein. Rather, these embodiments are provided so that this disclosure will be thorough and complete, and will fully convey their scope to those skilled in the art. In the drawings, like numbers refer to like elements throughout.

In the following description and/or claims, the terms “on,” “overlying,” “disposed on” and “over” may be used in the following description and claims. “On,” “overlying,” “disposed on” and “over” may be used to indicate that two or more elements are in direct physical contact with one another. Also, the term “on,”, “overlying,” “disposed on,” and “over”, may mean that two or more elements are not in direct contact with one another. For example, “over” may mean that one element is above another element while not contacting one another and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

In various embodiments, a novel pre-charge component and pre-charge circuit is provided for protecting a battery circuit. The novel pre-charge circuit of the present embodiments, may be used to manage current flow in an electric circuit that includes a battery circuit. Suitable applications for the pre-charge circuit of the present embodiments includes a battery circuit of an electric vehicle. Batteries may be used to power various loads or components in an electric vehicle, including a motor. In such circuits the pre-charge component is formed of a hybrid or heterogeneous thermistor arrangement, including both a negative temperature coefficient resistance (NTC) component and a polymer positive temperature coefficient resistance (PPTC) component. As such, the cold resistance may be customized to limit peak charging current to less than the limitation of an SCR or similar component in the pre-charge circuit. The novel pre-charge circuit of the present embodiments also provide dynamic resistance change during capacitor charging to withstand a high current, in a small package size. Moreover, as detailed below, the heterogeneous thermistor component, by integrating a PPTC, will protect the NTC component from an overtemperature condition in case of a short circuit fault.

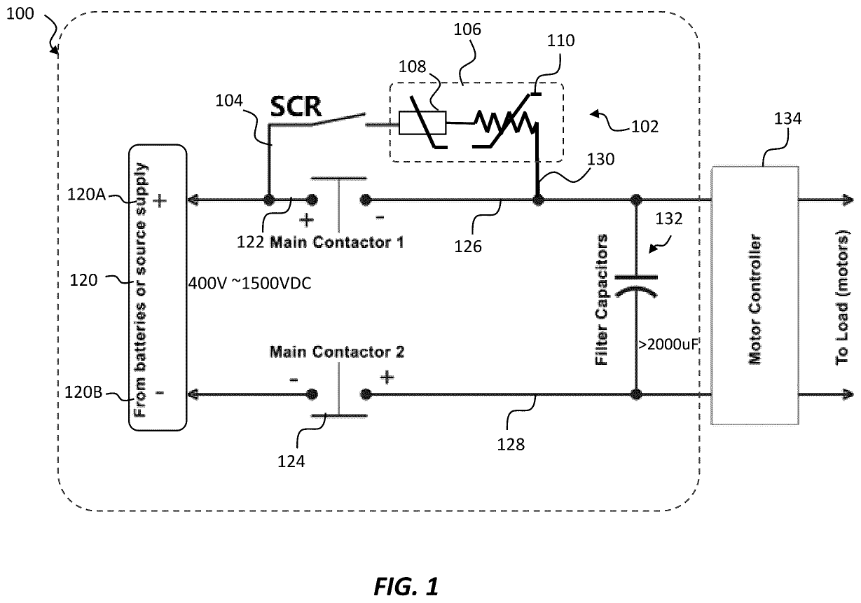

Turning to the FIG. 1 there is shown an electric circuit 100, according to embodiments of the disclosure. The electric circuit 100 may include a first terminal line 126 for connecting an external component, such as a motor, to a first terminal 120A of a battery 120. The electric circuit 100 may also include a first main contactor 122, connected in series along the first terminal line 126. In this example, the first terminal line 126 is connected to a positive terminal of the battery 120. The electric circuit 100 further may include a second terminal line 128 for connecting the external component to a second terminal 120B of the battery 120, as well as a second main contactor 124, connected in series along the second terminal line 128. When closed, the first main contactor 122 and the second main contactor 124 will complete a circuit that couples the battery 120 to drive external component(s), such as a motor(s). Likewise, when closed, the first main contactor 122 and the second main contactor 124 will complete a circuit to allow charging of the battery 120. The electric circuit 100 may further include a component that is termed a pre-charge circuit 102, connected along a pre-charge path 130 that extends parallel to the first main contactor 122, between the first terminal 120A and external component(s) (see, for example, motor controller 134 and load, as examples of external components.

According to the present embodiments, the pre-charge circuit 102 may include a silicon-controlled rectifier, shown as SCR 104, as well as a heterogeneous thermistor circuit 106. The heterogeneous thermistor circuit 106 may include a negative temperature coefficient resistance (NTC) component 108, as well as a polymer positive temperature coefficient resistance (PPTC) component 110, arranged in electrical series with the SCR 104. The term ‘heterogenous thermistor’ as used herein may refer to a component or circuit that includes an NTC component, arranged in series with a PPTC component. This pre-charge circuit 102 may be suitable to replace existing pre-charge circuit contactors.

An advantage of this heterogeneous thermistor circuit 106, is that the overall pre-charge circuit is simpler, smaller, and more cost efficient than a pre-charge circuit using a simple resistor, for example. The use of the NTC component 108, for example, allows the overall resistance of the heterogeneous thermistor circuit 106 to be customized according to the use temperature of the pre-charge circuit 102. The use of the PPTC component 110 by integrating a PPTC, will protect the NTC component 108 from an overtemperature condition in case of a short circuit fault.

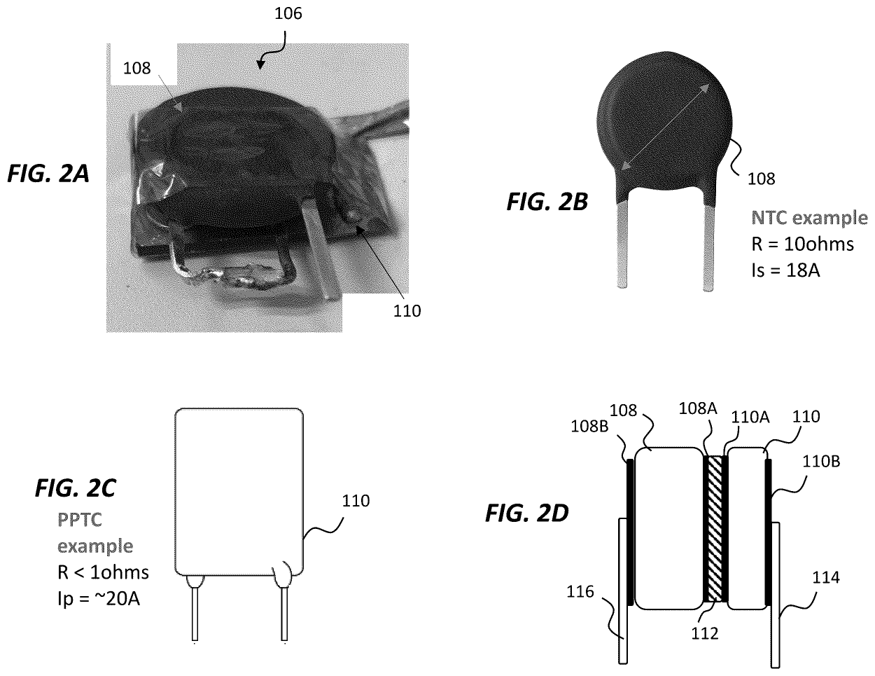

FIG. 2A depicts a perspective view of a variant of the heterogeneous thermistor circuit 106, according to embodiments of the disclosure. FIG. 2B depicts a plan view of an NTC component 108 of the heterogeneous thermistor circuit 106, according to embodiments of the disclosure. FIG. 2C depicts a plan view of a PPTC component 110 of the heterogeneous thermistor circuit 106 according to embodiments of the disclosure. FIG. 2D depicts a side view of a variant of the heterogeneous thermistor circuit 106 according to embodiments of the disclosure. Note that, in various embodiments as illustrated in FIG. 2D, the PPTC component 110 and NTC component 108 may be thermally coupled to one another using, for example, a thermal coupler 112, which coupler is disposed between a main surface of the NTC component 108 and a main surface of the PPTC component 110. The thermal coupler 112 may also be an electrical conductor that acts to electrically connect the PPTC component 110 and NTC component 108. While shown as a flat structure in FIG. 2D, in some embodiments the thermal coupler 112 may be a wire that is an electrical conductor and a thermally conductive wire that electrically and thermally couples the PPTC component 110 and NTC component 108. Note that the PPTC component 110 and NTC component 108 may each be provided with metallized surfaces that act as an electrode. These surfaces are shown as surface 108A and surface 110A. In addition, the PPTC component 110 and NTC component 108 may each be provided with outer metallized surfaces that act as an electrode. These surfaces are shown as surface 108B and surface 110B. These latter surfaces act as electrodes that may couple to external leads, shown as lead 116 and lead 114.

Note that according to various embodiments, the individual components and overall size of the heterogeneous thermistor circuit 106 may be relatively compact, as illustrated in FIG. 2B and FIG. 2C, for example. One non-limiting embodiment may limit the diameter of the NTC component 108 to 36 mm. As an example, the NTC component 108 may be a known ceramic NTC that is in the shape of a disc, having a maximum thickness of 8.5 mm. In one non-limiting embodiment the PPTC component 110 may be a rectangular disc, such as a square disc having a size of 30 mm along one edge and 30 mm along the perpendicular edge.

According to some embodiments, the NTC component 108 may exhibit a relatively higher resistance (for comparison, this resistance may be a room temperature (RT) resistance), while the PPTC component exhibits a relatively lower (RT) resistance, such as 1 Ohm or less. Returning to FIG. 1, during operation of the electric circuit 100, when the battery 120 is to be disconnected from an external load, the first main contactor 122 and the second main contactor 122 are maintained in an open position, as shown. During this first state, the first terminal line 126 and second terminal line are thus disconnected from the external load. In a pre-charge state, the second main contactor 124 is placed in a closed position, and a current is passed through the pre-charge circuit 102. The SCR 104 or similar component may act as a switch to connect the pre-charge circuit to the battery 120. During a charging state, the first main contactor 122 is closed while maintaining the second main contactor 124 also in a closed position. In a fault condition, when the first main contactor 122 fails to close at the appropriate time, excess current may be driven through the pre-charge circuit 102, in which circumstance the PPTC component 110, by tripping at a predetermined temperature, may protect the NTC component 108 from overheating.

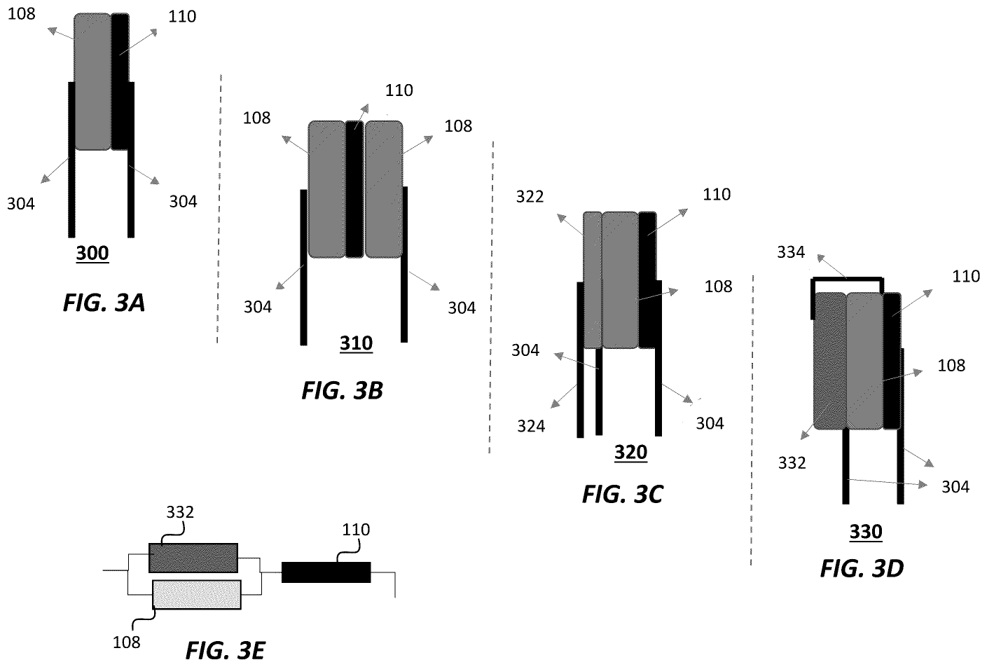

FIG. 3A shows a side view of a heterogeneous thermistor circuit 300 according to embodiments of the disclosure. In this embodiment, external leads 304 are coupled to each of the NTC component 108 and PPTC component 110. The heterogeneous thermistor circuit 300 includes just one NTC component and just one PPTC component. In this simple design, the overall size of the heterogeneous thermistor circuit 300 may be minimized.

FIG. 3B shows a side view of a heterogeneous thermistor circuit 310 according to embodiments of the disclosure. In this embodiment, a pair of NTC components, each shown as NTC component 108, are affixed to opposite sides of the PPTC component 110. In this configuration, the width of the heterogeneous thermistor circuit 310 may be greater than the width of the heterogeneous thermistor circuit 300. However, during operation, the advantage of this embodiment is that, when excess current is driven through the heterogeneous thermistor circuit 310, both main surfaces (left side vertical and right side vertical) of the PPTC component 110 will be heated equally by the provision of a NTC component 108 adjacent each of the main surfaces. In this manner, the PPTC component 110 is more likely to heat up uniformly an properly trip in a timely fashion.

FIG. 3C shows a side view of a heterogeneous thermistor circuit 320 according to embodiments of the disclosure. In this embodiment the PPTC component 110 is arranged on a first side of the NTC component 108, while a heating element 322, is arranged on a second side of the NTC component 108, opposite the first side. In this embodiment, a heater lead may be provided to independently provide current to the heating element 322 to heat the NTC component 108 and PPTC component 110. The heterogeneous thermistor circuit 320 may further include sensor circuitry (not separately shown) to determine when to turn on the heating element 322. For example, when ambient conditions for a battery circuit are below a certain threshold temperature, such as 0° C., for example, the heterogeneous thermistor circuit 320 may determine to provide heat to increase the temperature of the NTC component 108 and PPTC component 110. This provision of independent heating may be useful, since at lower temperature, the resistance of the NTC component 108 may be unduly high, so that the heating element 322 may bring the resistance of the NTC component 108 down to a suitable operating range by increasing the temperature locally of the heterogeneous thermistor circuit 320.

FIG. 3D shows a side view of a heterogeneous thermistor circuit 330 according to embodiments of the disclosure. In this embodiment, a first PPTC component, represented by PPTC component 110, is arranged on a first side of the NTC component 108 and a second PPTC component 332 is arranged on a second side of the NTC component 108, opposite the first side. As such, the NTC component 108 is arranged in electrical parallel fashion with the second PPTC component 332 via line 334, and the NTC component 108 and second PPTC component 332 are arranged in electrical series with the first PPTC component 110 (see FIG. 3E). In operation, the second PPTC component 332 acts as a resistance balancing PPTC component that balances out the resistance behavior of the NTC component 108. In other words, during a temperature range, such as below the trip temperature of the PPTC component 110, the overall resistance of the heterogeneous thermistor circuit 330 will be determined by a combination of the resistance of the second PPTC component 332 and the NTC component 108. As temperature varies over a given range, depending upon the absolute resistance of each of these components, the resistance of the heterogeneous thermistor circuit 330 will be dominated more by the resistance of the NTC component 108 of the second PPTC component 332. Note that as temperature increases, the resistance of NTC component 108 will decrease while the resistance of the second PPTC component 332 will increase. Thus, by suitable choice of NTC and PPTC components, a suitable resistance behavior as a function of temperature may be achieved, in particular, a less variable resistance may be achieved over a desired temperature range.

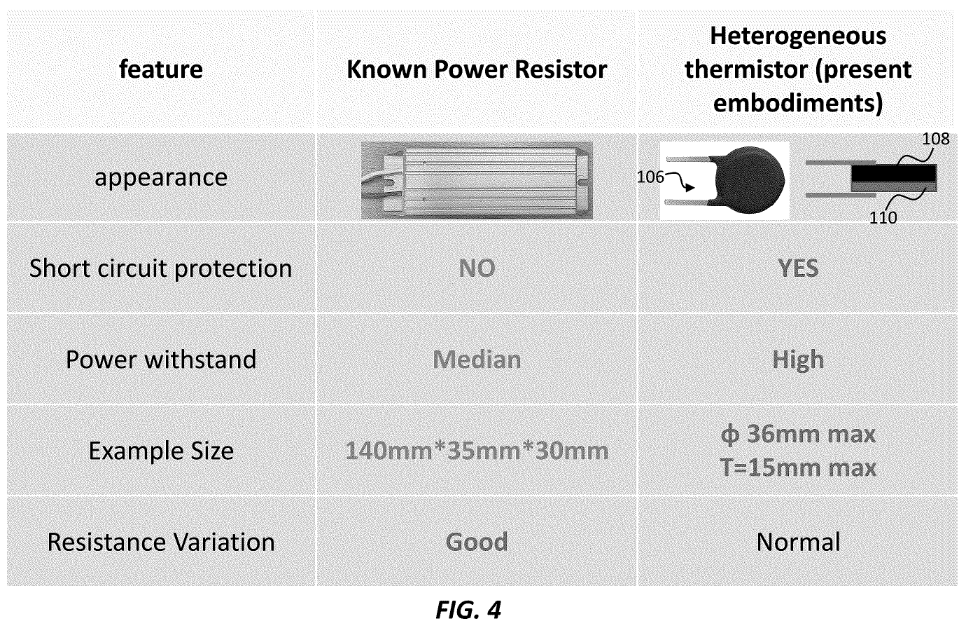

FIG. 4 is a composite illustration showing a comparison of a known resistor and a heterogeneous thermistor circuit according to embodiments of the disclosure. A shown, the heterogeneous thermistor circuit of the present embodiments provides short circuit protection, higher power withstanding, and a much smaller overall size.

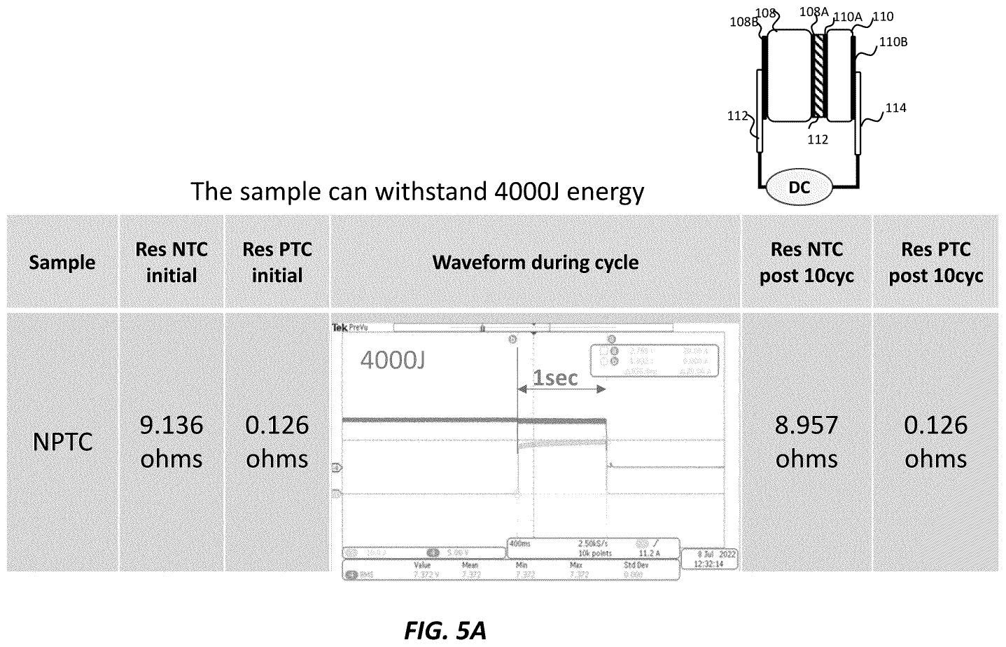

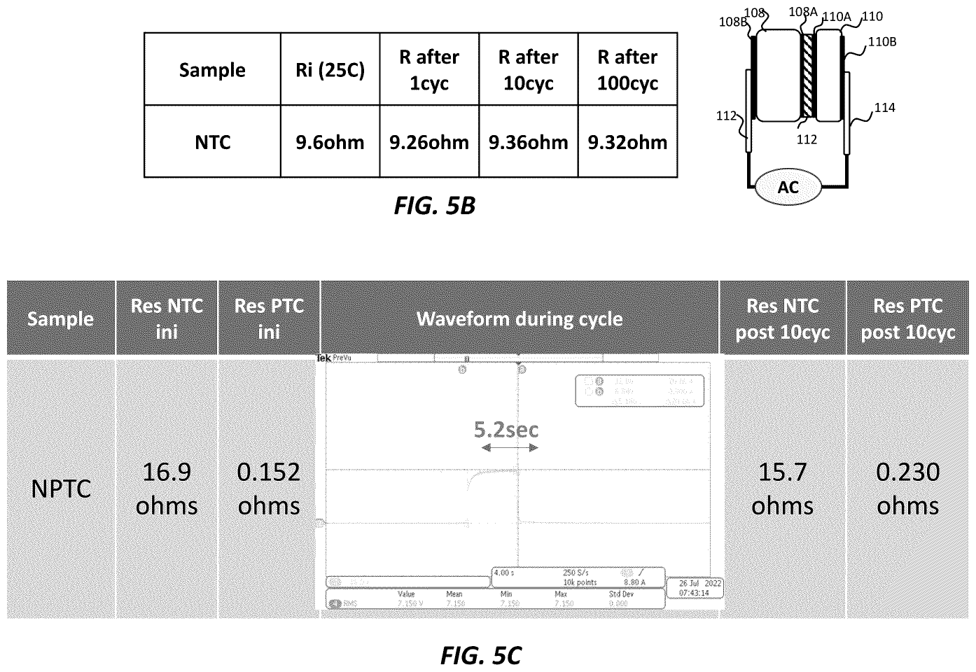

FIG. 5A is a composite illustration showing an exemplary set of waveforms for a high voltage DC test, and a summary of DC test results for a heterogeneous thermistor circuit according to embodiments of the disclosure. In particular, as shown in the insert, an NTC component and PPTC component are arranged in electrical series with one another under the Test conditions: 400 VDC/20 A, 1 sec on/120 sec OFF for a given cycle, with a total of 10 cycles. The results shown essentially no change in resistance between the NTC component and PPTC component before and after the performance of the test, indicating that the sample can withstand at least 4000 J energy. In contrast, when a prior art resistor (50 W, 20 Ohm; dimensions: 50 mm×30 mm×16 mm) used for pre-charge circuits was subject to a 24V/1 A test, the results after testing indicate fusing of parts of the resistor coil, where a temperature of above 400° C. was generated.

FIG. 5B presents a summary of NTC component results for high voltage AC test of a heterogeneous thermistor circuit according to embodiments of the disclosure. In particular, as shown in the insert, an NTC component and PPTC component are arranged in electrical series with one another under an applied AC voltage where the test condition is 600 Vac/15A, 30 sec on/120 sec OFF for a given test cycle. The results shown a couple percent decrease in RT resistance of the NTC component after one cycle, and no systematic change thereafter up to 100 cycles. Thus, the NTC component can survive under 600 Vac/15 A conditions.

FIG. 5C is a composite illustration showing an exemplary set of waveforms for a high voltage DC test, simulating short circuit conditions, and a summary of DC test results for a heterogeneous thermistor circuit according to embodiments of the disclosure. The test conditions that apply are the performance of 10 cycles where a given cycle involves the application of 400 V DC/20 A, 15 sec on/120 sec OFF. The results indicate just a small change in room temperature resistance for both NTC and PPTC components of the heterogeneous thermistor, meaning the sample achieves superior self-protection results.

While the present embodiments have been disclosed with reference to certain embodiments, numerous modifications, alterations and changes to the described embodiments are possible while not departing from the sphere and scope of the present disclosure, as defined in the appended claims. Accordingly, the present embodiments are not to be limited to the described embodiments, and may have the full scope defined by the language of the following claims, and equivalents thereof.

What is claimed is:

1. A pre-charge circuit, comprising:
a switching device for controlling a voltage to be supplied to a battery; and
a heterogeneous thermistor circuit, coupled to the switching device, wherein the heterogeneous thermistor circuit comprises:
a negative temperature coefficient (NTC) component; and
a polymer positive temperature coefficient (PPTC) component, arranged in electrical series with the NTC component and the switching device.

2. The pre-charge circuit of claim 1, wherein the switching device and heterogeneous thermistor circuit are disposed along a pre-charge path that is arranged in electrically parallel fashion with a terminal line, the terminal line for coupling to a battery terminal of the battery.

3. The pre-charge circuit of claim 2, wherein a first end of the pre-charge path is coupled on a first side of a main contactor, arranged on the terminal line, and wherein a second end of the pre-charge path is coupled on second side of the main contactor.

4. The pre-charge circuit of claim 1, wherein the PPTC component is thermally coupled to the NTC component.

5. The pre-charge circuit of claim 1, wherein the NTC component is arranged as a ceramic NTC component.

6. The pre-charge circuit of claim 1, wherein the switching device is a silicon controlled rectifier (SCR).

7. The pre-charge circuit of claim 1, wherein the PPTC component is a first PPTC component that is arranged on a first side of the NTC component, the pre-charge circuit further comprising a second NTC component, arranged on a second side of the PPTC component, opposite the first side.

8. The pre-charge circuit of claim 1, wherein the PPTC component is arranged on a first side of the NTC component, the pre-charge circuit further comprising a heating element, arranged on a second side of the NTC component, opposite the first side.

9. The pre-charge circuit of claim 1, wherein the PPTC component is a first PPTC component that is arranged on a first side of the NTC component, the pre-charge circuit further comprising a second PPTC component, arranged on a second side of the NTC component, opposite the first side, wherein the NTC component is arranged in electrical parallel fashion with the second PPTC component, and wherein the NTC component and second PPTC component are arranged in electrical series with the first PPTC component, and the switching device.

10. The pre-charge circuit of claim 1, wherein the heterogeneous thermistor circuit is arranged to withstand a test sequence without degradation, the test sequence comprising a sequence of ten test cycles, wherein each test cycle of the sequence of ten test cycles comprises 400V DC/20 A, 1 sec on/120 sec OFF.

11. A battery circuit, comprising:
a first terminal line for connecting an external component to a first terminal of a battery;
a first main contactor, connected in series along the first terminal line; and
a pre-charge circuit, connected along a pre-charge path that extends parallel to the first main contactor, between the first terminal and the external component, the pre-charge circuit comprising:
a silicon-controlled rectifier (SCR); and
a heterogeneous thermistor circuit, coupled in electrical series to the SCR, wherein the heterogeneous thermistor circuit comprises:
a negative temperature coefficient (NTC) component; and
a polymer positive temperature coefficient (PPTC) component, arranged in electrical series with the negative temperature coefficient (NTC) component and the SCR.

12. The battery circuit of claim 11, wherein the PPTC component is thermally coupled to the NTC component.

13. The battery circuit of claim 11, wherein the NTC component is arranged as a ceramic NTC component.

14. The battery circuit of claim 11, wherein the PPTC component is a first PPTC component that is arranged on a first side of the NTC component, the pre-charge circuit further comprising a second NTC component, arranged on a second side of the PPTC component, opposite the first side.

15. The battery circuit of claim 11, wherein the PPTC component is arranged on a first side of the NTC component, the pre-charge circuit further comprising a heating element, arranged on a second side of the NTC component, opposite the first side.

16. The battery circuit of claim 11, wherein the PPTC component is a first PPTC component that is arranged on a first side of the NTC component, the pre-charge circuit further comprising a second PPTC component, arranged on a second side of the NTC component, opposite the first side, wherein the NTC component is arranged in electrical parallel fashion with the second PPTC component, and wherein the NTC component and second PPTC component are arranged in electrical series with the first PPTC component, and the SCR.

17. A heterogeneous thermistor circuit for use in a pre-charge circuit, comprising:
a negative temperature coefficient (NTC) component;
at least one polymer positive temperature coefficient (PPTC) component, arranged in electrical series with the negative temperature coefficient (NTC) component; and
a thermal coupler, disposed between the at least one PPTC component and the NTC component.

18. The heterogeneous thermistor circuit of claim 17, wherein the PPTC component is a first PPTC component that is arranged on a first side of the NTC component, the pre-charge circuit further comprising a second NTC component, arranged on a second side of the PPTC component, opposite the first side.

19. The heterogeneous thermistor circuit of claim 17, wherein the PPTC component is arranged on a first side of the NTC component, the pre-charge circuit further comprising a heating element, arranged on a second side of the NTC component, opposite the first side.

20. The heterogeneous thermistor circuit of claim 17, wherein the PPTC component is a first PPTC component that is arranged on a first side of the NTC component, the pre-charge circuit further comprising a second PPTC component, arranged on a second side of the NTC component, opposite the first side, wherein the NTC component is arranged in electrical parallel fashion with the second PPTC component, and wherein the NTC component and second PPTC component are arranged in electrical series with the first PPTC component.
